(19) United States
(12) Patent Application Publication
(10) Pub. No.: US 2024/0367633 A1
(43) Pub. Date: Nov. 7, 2024

(54) METHOD FOR DETERMINING A STATE OF WEAR OF A BRAKE PAD OF A VEHICLE, AND DEVICE AND COMPUTER PROGRAM

(71) Applicant: Robert Bosch GmbH, Stuttgart (DE)

(72) Inventors: Hannes-Sebastian Zechlin, Leonberg (DE); Andreas Hoffmann, Obersulm (DE); Mirko Scheer, Besigheim (DE); Christian Weissenbacher, Karlsruhe (DE); Devi Raj Sunkara, Bangalore, Karnataka (IN); Stephan Georg Lehner, Wallduern-Altheim (DE)

(21) Appl. No.: 18/568,423

(22) PCT Filed: Jun. 14, 2022
(86) PCT No.: PCT/EP2022/066143

§ 371 Date: Dec. 8, 2023

(30) Foreign Application Priority Data
Jun. 28, 2021 (DE) 10 2021 206 661.5

(51) Int. Cl. B60T 17/22; F16D 66/00; F16D 66/02

(52) U.S. Cl. CPC B60T 17/22; F16D 66/026; B60T 2240/03; B60T 2250/00; F16D 2066/001; F16D 2066/003; F16D 2066/006

(57) ABSTRACT

A method for determining a state of wear of a brake pad of a vehicle. The method includes: receiving time series data, the time series data including a time series of brake system-related data of the vehicle; identifying at least one braking event in the time series data, each braking event identified in the time series data corresponding to a temporal data window of braking event data of the time series data, the data window correlating with a real braking event of the vehicle; determining features from the braking event data by using predetermined operators for each identified braking event; classifying the at least one braking event by using the features determined for this purpose, the classification being associated with a state of wear of the brake pad of the vehicle.

### FIELD

The present invention relates to a method for determining and in particular continuously monitoring a state of wear of a brake pad of a vehicle, and to a device and a computer program for this purpose.

### BACKGROUND INFORMATION

Hydraulic brake systems, as used in vehicles, for example in the area of passenger cars or in the area of commercial vehicles, are provided in such a way that they decelerate wheels by a torque generated by friction. Normally, a brake caliper moves brake pads against a rotating rotor, in particular a brake disk, which is firmly connected to the wheel. Thus, a frictionally engaged surface contact is established between the brake pad and the brake disk. The thermally conductive brake pads are designed for wear in order to ensure a long-lasting brake system. Standards regarding vehicle safety, error avoidance, maximization of the service life of the brake caliper-rotor system, vehicle monitoring and maintenance as well as vehicle fleet and supply chain management require monitoring of the brake pad wear.

The detection of wear of brake pads is based essentially on a combination of direct and indirect detection approaches: The thickness of the pad material may be measured or monitored directly by hardware sensors (direct sampling). Indirect measurement methods derive the pad thickness or its state of wear from previously defined system parameters and data from environment sensors.

Customary brake pad wear sensors, BPWS, comprise electrical circuits, which are embedded into the friction material of the brake pad perpendicularly with respect to the wear direction of the pad. The sensors are normally mounted on or in direct proximity of the pad plate of the brake pad. BPWS may have several stages in order to classify the state of wear of the pad, which result from the stepwise change in resistance when the electrical circuits are destroyed by brake pad wear. As such, these sensors are destroyed in the course of the wear of the pad (destructive sampling).

Approaches to non-destructive sampling comprise sensor systems that use other methods for the direct or indirect measurement of the pad thickness. Examples are position sensors or distance measurements on the basis of ultrasound technology.

The evaluation of the sensor signals may be combined with more complex software algorithms. Current algorithms normally refer to the surface temperature of the brake disk, which is obtained either by an additional hardware sensor or by a software algorithm, which is based on measured variables supplied by other sensors and on variables supplied by the brake system. A brake disk temperature model, BTM, is used in order to derive the disk temperature from the physical work applied by the brake pad and the radiative disk cooling. The main parameters of the BTM are the application pressure, the wheel speed and the ambient temperature, apart from coefficients relating to the wheel, pad and brake system characteristic.

The brake pad wear ΔWz is derived from physical modeling. In a first approximation, ΔWz is a linear function of the energy Eb dissipated during a braking event, i.e., ΔWz∝Eb for every braking event. The proportionality constant of this model, K, in turn normally depends on the pressure, wheel speed and the disk temperature (provided by the BTM) and is normally approximated by a polynomial. The total wear of a brake pad at a current time t0 is derived by summing the ΔWz estimates of all previously performed braking events (integral approach). Multi-stage BPWS are used both for the stepwise recalibration of the highly uncertain model prediction and as a safety unit in the case of completely worn brake pads (driver warning).

The integral approach to calculating the total brake pad wear is based on the assumption, however, that the brake pads are exchanged for new brake pads of the same type (brand, model). The use of already worn brake pads of a different type would require an initial recalibration of the installed model, which current implementations are unable to handle. Secondly, systematic uncertainties of the model prediction, or brake pad behavior that is not modeled, are integrated, which continuously increases the measurement uncertainty up to the model recalibration by the BPWS measurement. Furthermore, current BTM implementations have a high uncertainty (≤100 K) with respect to the estimated brake disk temperature. BTM implementations therefore fulfill only the ASIL A standard (Automotive Safety Integration Level). The substitution of the BTM with hardware sensors for the brake disk temperature instead results in a great increase of the product costs. Internal BPWS, which are incorporated into the pad material of the brake pad, are eventually expended with the wear of the brake pad. Replacing the pad thus requires replacing the sensor, which increases the maintenance costs incurred.

### SUMMARY

According to one aspect of the present invention, the method for determining a state of wear of a brake pad of a vehicle includes the following steps. In one step, time series data are received, the time series data comprising a time series of vehicle data relevant for the brake system. In a further step, at least one braking event is identified in the time series data, each braking event identified in the time series data corresponding to a temporal data window of braking event data of the time series data, the data window correlating with a real braking event of the vehicle. In a further step, features are determined from the braking event data by using predetermined operators for every identified braking event. In a further step, the at least one braking event is classified by using the features determined for this purpose, the classification being associated with a state of wear of the brake pad of the vehicle.

The term “state of wear of the brake pad”, as it is used here, comprises in particular a thickness of the brake pad.

The time series data thus comprise a plurality of data sets of a source over multiple time steps.

In other words, the determined features describe a system behavior of the vehicle, in particular of the brake system, during a braking event. On the basis of the determined features, it is possible to classify the analyzed braking event or, in other words, to make an assertion regarding the quality of the braking event. Assuming that the quality of the braking event correlates directly with the state of wear of the brake pad, an assertion regarding the state of wear of the brake pad will be made on the basis of the classification of the braking event.

According to an example embodiment of the present invention, the classification of the at least one braking event preferably comprises a classification of the at least one braking event by a, particularly pretrained, machine learning model using the features determined for this purpose, the machine learning model determining a probability for the at least one braking event for every classification, and an assignment of a class to the at least one braking event using the determined probabilities.

According to an example embodiment of the present invention, the machine learning model is preferably trained automatically during an initial breaking-in phase, for example during the first 10,000 km. Further preferably, the machine learning model is trained automatically following an exchange of the brake pads, for example during the first 10, 000 km following the exchange of the brake pads.

According to an example embodiment of the present invention, the machine learning algorithms of the machine learning model may use methods such as logistic regression, neural networks, random forests and the like. Models that are implemented in an active brake pad state monitoring system of a vehicle may be pretrained prior to delivery of the vehicle system or may be self-learning during the breaking-in periods of the vehicle.

The time series data, that is, the input data, are represented by time series Sk(t) with individually varying samplings. The index k∈N indicates the kth signal or data source. The variable t indicates the time. All data types of the time series data are provided by brake system-related hardware or control software, including standard vehicle state data sources or environment data sources such as an inertia measurement unit.

A braking event preferably has a length of under 10 seconds, further preferably of under 5 seconds.

The time series data are characterized by statistical features that are derived for all time series data within each data window. Statistical estimators or mathematical operators that are taken into account for determining the features comprise for example quantiles, standard deviations, average values, minimum values and/or maximum values.

According to an example embodiment of the present invention, for every braking event, that is, data window, the features, or in particular an optimized set of features, are provided to the machine learning model, which was pretrained for the event classification. The machine learning model preferably uses a supervised logistic regression classifier, which represents a standard method for classification problems. Due to the low numerical and computational complexity of trained logistic regression models, embedded implementations in control devices are facilitated in this manner. Alternative versions of the classification algorithm are able to use other supervised machine learning classifiers, e.g., a random forest, both in vehicle-internal as well as in external, for example cloud-based, implementations. In order to avoid a general pretraining of the classifier, that is, of the classification of the braking event, or a vehicle-specific training, it is possible to use unsupervised machine learning models.

According to an example embodiment of the present invention, the machine learning model further preferably uses logistic regression. Logistic regression is a linear probabilistic discriminative model for classification. Discriminative means that the model learns a mapping function, which is generally called a discriminant function and which maps input data onto a class. Probabilistic means that the discriminant function is learned on the basis of statistically distributed input data and their respective classes.

According to an example embodiment of the present invention, the event classification, that is, the formal assignment of a brake pad state of wear class to a given braking event, is based on a probabilistic approach. In the basic approach, an individual event is assigned to the class that has the highest probability. In the exemplary case of two state of wear classes, C∈{good, poor}, the classification threshold is given by a probability value of 0.5. Multiple classes may be handled in an analogous manner, for example by generalizing the logistic regression to more than two state of wear classes.

The presented approach according to the present invention thus allows for the classification, and thus also for the measurement, of the pad thickness of brake pads on the basis of individual independent braking events, represented by time series data from vehicle sensors and brake system sensors or, respectively, data and states. In comparison to the integral approaches discussed in the related art, a differential approach is chosen here for estimating the state of wear of the brake pad. Accordingly, an integral analysis of the state of wear of the brake pad over a longer time period is not necessary.

By analyzing individual braking events and generating features of the respectively associated time series data, the overall behavior of the brake system and of the vehicle is analyzed, and an estimation of the wear of the brake pad is performed on this basis.

In this manner, a more accurate method is provided for determining the state of wear of the brake pad. The uncertainties are reduced significantly in comparison to integral methods. Additionally, it is thus also possible to use and monitor replacement brake pads of other manufacturers (for example when changing the pads).

Due to the purely, or at least mainly, model-based approach, no additional direct sensors on the brake pad are required, which directly measure for example a thickness of the brake pad and which are normally comparatively complex and cost-intensive.

In this manner, an improved method is provided for determining the state of wear of the brake pad.

According to a preferred specific embodiment of the present invention, the braking-related data comprise sensor data, control device data and/or brake system data of the vehicle.

The time series data comprise preferably a plurality of braking-related data, in particular raw data, over time.

According to a preferred specific embodiment of the present invention, the sensor data are provided by a master brake cylinder pressure sensor, a tire rotational speed sensor, a vehicle inertial sensor and/or a brake system sensor.

The sensor data preferably comprise measurements of time-dependent physical variables. Further preferably, measurements by sensors of the vehicle for determining sensor measurements are performed at a predetermined frequency. In other words, a signal sampling is performed.

According to an example embodiment of the present invention, the brake system sensors preferably comprise a sensor for determining the brake fluid volume displaced by the brake system.

The control data preferably comprise data generated from sensor data.

According to an example embodiment of the present invention, the control device data preferably comprise various variables, in particular physical variables, which are derived from sensor data, system data or software data. The data are provided as a function of time, in particular as a sampled function of time.

According to a preferred specific embodiment of the present invention, the brake system data comprise a brake system status and/or a brake system flag.

According to an example embodiment of the present invention, the brake system data preferably comprise brake system requirements, brake system settings and function activations or operating modes of the brake system, as a function of time.

According to a preferred specific embodiment of the present invention, the identification of the at least one braking event comprises the following steps. Receiving at least one brake trigger, the brake trigger correlating with a real braking event of the vehicle, and identifying the at least one braking event by using the at least one received brake trigger.

The identification of the at least one braking event preferably comprises a selection of time series data, which are stored for example in a memory, the selected time series data being assigned to a braking event.

Preferably, the brake trigger is received from outside.

Fundamentally, according to an example embodiment of the present invention, the state of wear of the brake pad is evaluated on the basis of braking events. For this reason, the time series data are divided into time intervals, which are also referred to as data windows. The lengths of these time intervals are chosen in such a way that they cover individual, isolated braking events completely and thus provide unequivocal data sets for the braking event analysis.

For example, the brake trigger comprises a state of a brake light switch signal, that is, a signal that indicates whether the brake light is activated or not, a velocity signal, that is, a signal that indicates at what velocity the vehicle is moving, and/or a motor state signal, that is, a signal that indicates the state of the motor.

Preferably, according to an example embodiment of the present invention, the start of a braking event is determined when the brake light switch signal indicates “active”, the velocity signal exceeds a predetermined value, for example 0.1 m/s, and the motor state signal indicates “active”.

Since the braking duration for each braking event varies, it is important to select the portion of a braking event that provides significant information for the classification. For example, a fixed window size is defined, which is applied to all braking events and which is optimized during the training of the machine learning model. The time window is indicated by a tuple (ts, Δtw), where ts is the relative start time of the window and Δtw is the length of the window. All data points of the time series data outside of the interval [ts, ts+Δtw] are cut off. Braking events that do not satisfy the minimum requirements of the given window, for example brief events, are not considered for the analysis. Alternatively, different time windows may be defined, which are treated mathematically using an event normalization method.

Alternatively, the braking event comprises a buffer time. In other words, the braking event comprises time series data prior to and following the actual braking event. Time series data with a previously defined buffer time prior to and/or following the brake trigger are thus assigned to the respective braking event.

In a preferred specific embodiment of the present invention, the at least one brake trigger comprises a state of the brake light switch, a velocity of the vehicle and/or a motor state.

According to a preferred specific embodiment of the present invention, superfluous time series data, which cannot be assigned to a braking event, are discarded.

In other words, intervals of the time series data, which only contain data that were recorded within gaps between two successive braking events, are discarded.

According to a preferred specific embodiment of the present invention, time series data, which are not suitable for determining features, are discarded.

Not all braking events qualify for the analysis of the data regarding the brake pad wear. In particular, time series data that are classified as not valid are not suitable for determining features. For example, incomplete or incorrect data of the time series data are classified as not valid. In addition, the data selection may be performed on the basis of criteria for signal parameters, for example criteria for vehicle movement, braking intensity and length, in addition to others. Furthermore, restrictions of the classification, that is, in particular of a classification algorithm, with respect to sensitivity, system, or model-internal limitations, may result in individual data packets being excluded from the data analysis.

The event selection thus imposes restrictions in the data selection.

According to a preferred specific embodiment of the present invention, the method comprises an assignment of a relevance to each of the determined features and a use of a previously defined number of features having the highest relevance for classifying the at least one braking event.

During the training of the machine learning model, first a multitude of features is taken into account and is ordered iteratively according to relevance, that is, according to their influence on the classification probability derived from the classifier. Altogether, for example the 15 most relevant features are subjected to the classification algorithm, that is, feature selection and feature optimization according to the method of recursive feature elimination. Further optimization criteria are the preference of uncorrelated time series, the resulting determination of an upper limit for the statistical correlation, and of a lower limit for the variance of the time series, in order to avoid nearly constant signals. Alternative algorithms may consider fewer or more features as a result of the model optimization.

According to a preferred specific embodiment of the present invention, the reception of time series data comprises the following steps. Storing the received time series data in a memory, the time series data being retained in a memory for as long as the memory is not exhausted or as long as the features of the corresponding time series data have not been determined.

According to a preferred specific embodiment of the present invention, the at least one braking event is classified by taking into account a braking history of the vehicle.

The braking history preferably comprises an assumption that a continuous wear process is assumed and included. Further preferably, the braking history comprises features of multiple successive braking events. Further preferably, the braking history comprises potential brake anomalies, which were detected in earlier braking events.

According to a preferred specific embodiment of the present invention, the method comprises a reception of temperature data, the temperature data comprising a temperature of the brake pad, a temperature of a brake disk of the vehicle, in particular of the brake disk on which the brake pad is fastened, and/or an ambient temperature of the vehicle, and a classification of the at least one braking event by using the features determined for this purpose and the corresponding temperature data.

According to an example embodiment of the present invention, the temperature data of the brake pad preferably comprise a temperature of the brake pad on a side of the brake pad facing away from the brake disk. Based on the temperature on the side facing away from the brake disk, inferences may be drawn regarding the thermal conductivity of the brake pad and thus, inter alia, regarding the thickness of the brake pad.

According to an example embodiment of the present invention, the temperature data preferably also comprise an ambient temperature of the vehicle, further preferably an ambient temperature of the brake disk.

For reasons of accuracy of the temperature data, heating processes and cooling processes should be considered in the context of the ambient temperature of the vehicle.

In comparison to the features, the temperature data preferably are of particularly great significance, that is, correlation with the state of the brake pads.

According to an example embodiment of the present invention, the machine learning model is able to perform a particularly accurate classification with the aid of the temperature data together with the determined features.

According to a further aspect of the present invention, a device is provided, which is designed to implement the method for determining the state of wear of the brake pad, as it is described here.

According to a further aspect of the present invention, a computer program is provided, comprising commands that prompt a computer, when executing the computer program, to implement a method as it is described here.

Further measures improving the present invention are presented in greater detail below with reference to figures together with the description of the preferred exemplary embodiments of the present invention.

### DETAILED DESCRIPTION OF EXAMPLE EMBODIMENT

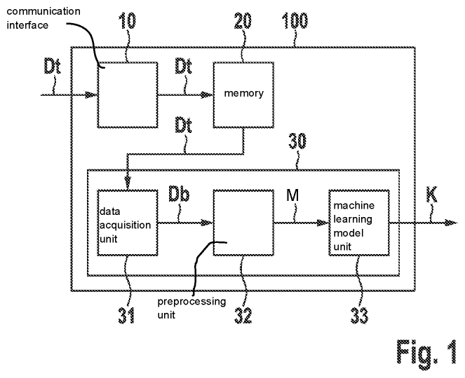

FIG. 1 shows a device for determining a state of wear of a brake pad.

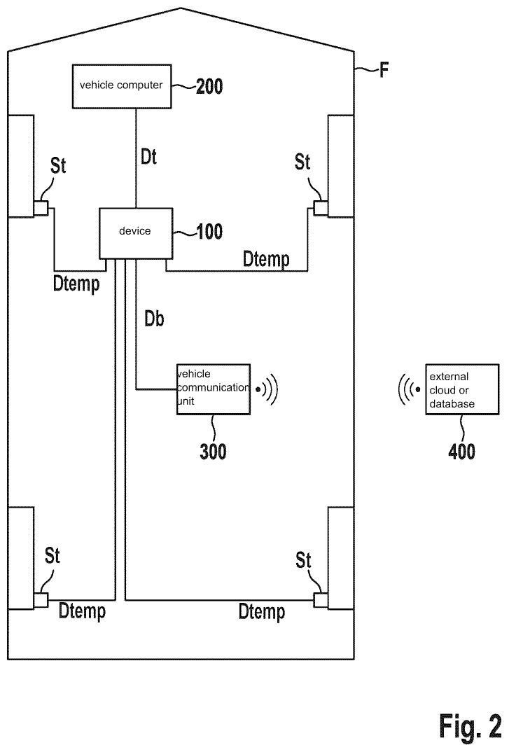

FIG. 2 shows a vehicle including a device for determining a state of wear of a brake pad.

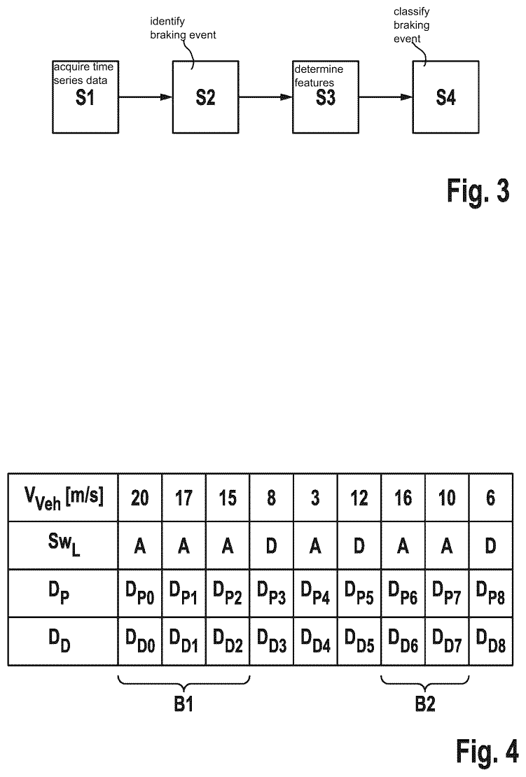

FIG. 3 shows a method for determining a state of wear of a brake pad.

FIG. 4 shows time series data in a data memory.

### DETAILED DESCRIPTION OF EXAMPLE EMBODIMENTS

FIG. 1 shows a device 100 for determining a state of wear of a brake pad, in particular an electronic control unit, of a vehicle F. The device preferably comprises components, which are available in a conventional control device for the brake system of vehicle F, but which offer sufficient performance for carrying out the determination of the state of wear of vehicle F. Device 100 comprises an electronic processor 30, for example a programmable microprocessor, microcontroller or another processor unit, a memory 20, for example a non-transitory, machine-readable memory, and a communication interface 10. The processor 30 is designed to execute software instructions related to the determination of the state of wear of the brake pad of vehicle F. Processor 30 may additionally execute other brake system processes. Processor 30 is able to read and write to memory 20. The communication interface 10 establishes a connection between device 100 and a vehicle communication bus of vehicle F, which is connected to other systems in the vehicle. In particular, the vehicle communication bus may be used to exchange data with a vehicle computer 200 or a vehicle communication unit 300. The vehicle communication unit 300 enables a connection of vehicle F to external entities. Device 100 is for example electrically connected to a master brake cylinder pressure sensor, to wheel speed sensors, to a vehicle inertial sensor and various internal sensors of the brake system of vehicle F. Alternatively, sensors outside of the system may also be connected, for example via the vehicle communication bus.

The communication interface 10 is designed to receive time series data Dt from the various sensors of vehicle F, from the brake system itself, or from the vehicle communication bus, the time series data comprising a time series of braking-related data of the vehicle. Memory 20 is designed to store the time series data Dt received from the communication interface 10. Processor 30 comprises a data acquisition unit 31, which is designed to identify at least one braking event B1, B2 in the time series data Dt. Each braking event B1, B2 identified in the time series data Dt corresponds to a temporal data window of braking event data Db of the time series data Dt, the data window correlating with a real braking event of vehicle F. Processor 30 comprises a preprocessing unit 32, which is designed to select braking events on the basis of predefined criteria and to determine features M from the braking event data Db by using predetermined operators for each identified braking event B1, B2. The braking event data Db are raw data, which are preprocessed by time filtering and the calculation of signal features by predetermined operators, such as for example minimum, maximum, average, standard deviation, absolute value and/or quantile, for further processing. Processor 30 comprises a machine learning model unit 33, which is designed to classify the at least one braking event by using the features M provided for this purpose. The classification K is assigned to a state of wear of the brake pad of vehicle F.

The device acquires sensor signals and signals of the brake system software in the form of time series data Dt. The time series data Dt are stored temporarily in memory 20. A sampling frequency, with which the time series data Dt are received, is defined in advance and may follow in particular the standard settings of the brake system.

The data acquisition unit 31 acquires braking event data Db that correspond to a temporal data window of time series data Dt. In other words, the braking event data Db refer to time series data Dt that correlate with a braking event of the vehicle F. The data acquisition unit 31 identifies a braking event B1, B2 of vehicle F and acquires from the time series data Dt the corresponding braking event data Db of the identified braking event B1, B2.

The identification of the braking event B1, B2 is performed by the data acquisition unit 31 using a brake trigger T. The brake trigger T is triggered for example by the driver of vehicle F, by the brake system or by an autonomous vehicle computer 200 of the vehicle F. The data acquisition ends when the braking request is fulfilled and the braking event is terminated. Alternatively, the data acquisition may also include a buffer time, that is, an acquisition of data before and after the identified braking event B1, B2. The braking event data Db are retained in the memory 20 for as long as the memory 20 is not exhausted and as long as a data preprocessing of the braking event data Db is not completed. Alternatively, the braking event data Db may be transmitted to other systems, in particular to the vehicle connection unit 300, via the communication interface 10 of device 100.

The detection and monitoring of the state of wear of the brake pad occurs on the basis of individual braking events B1, B2, the respective time series data Dt being analyzed in the process. In a purely model-based brake pad wear detection, which is also referred to as BPWD, a machine learning model 33 is used in order to classify the state of wear of the brake pad. States of wear may be defined via intervals of the remaining thickness of the brake pad material. Simple implementations consider tuples of two or three states as the basis for classification, that is, in particular (good, poor) or (new, used, worn). Alternatively, it is also possible to define more than three or other states.

BPWD uses brake system-related raw data, that is, in particular data of vehicle hardware, which vehicle hardware is normally present and does not have to be added separately. For sensor input signals, a special BPWD algorithm uses the master brake cylinder pressure, the wheel speed, vehicle acceleration and sensors inside the brake system, in particular rod travel and plunger movement. The software of the brake system additionally provides variables derived from raw sensor data, vehicle characteristics and braking request characteristics, in particular a wheel torque and braking request-related characteristics. Alternatively, other input data may also be taken into account, which are likewise retrieved from the vehicle communication bus.

As an alternative to the purely model-based approach, it is possible to use additionally a temperature sensor St on a pad plate of the brake pad as input for the machine learning unit 33. Alternatively, data from a brake disk temperature sensor may also be taken into account. Due to the influence of the brake pad temperature measurement, the machine learning model 33 is able to measure the brake pad thickness and thus the state of the brake pad with greater accuracy.

The analysis chain for braking event data Db comprises the following main tasks: First: event selection. Not all braking events B1, B2 qualify for analysis. The data selection may be performed on the basis of criteria of data validity, vehicle inertia, braking intensity, etc. Second: data preprocessing. The raw data are preprocessed for the analysis by predetermined operators such as time filtering and the calculation of features M (min, max, avg, standard deviation, module, quantile, etc.). Third: data analysis. The preprocessed features M are analyzed with the aid of the machine learning model 33. Fourth: classification. The braking events B1, B2 are classified on the basis of the analysis result, for example a state of wear label assigned by the machine learning model 33. The state of wear label, which is also referred to as classification K, corresponds to an estimation of the state of wear of the brake pad.

FIG. 2 shows a vehicle F including a device 100 for determining a state of wear of a brake pad.

Apart from device 100 for determining a state of wear of a brake pad of the vehicle, vehicle F comprises, in the form of an electronic control unit 100, a vehicle computer 200 and a vehicle communication unit 300. The required time series data Dt are supplied to the control unit 100 either via a direct sensor connection, the vehicle communication bus, or the vehicle computer 200. The vehicle computer 200 may also be used to provide the driver of the vehicle with access to the results of the determination of the state of wear of a brake pad or to display these results. In this case, each brake pad has a temperature sensor St, which provides the electrical control unit 100 with temperature data Dtemp. Vehicle F also has a vehicle communication unit 300, which is designed to transmit braking event data Db of the electronic control unit 100 to an external cloud or database 400. In this case, cloud 400 has a machine learning model, which is designed to ascertain the state of wear of the brake pads from the provided braking event data. In comparison to a machine learning model in the electronic control unit 100, it is possible to provide a comparatively more complex machine learning model in an external cloud 400, including more complex preprocessing or postprocessing algorithms. The resulting classifications of the respective braking events associated with the braking event data are then returned from the cloud 400 via the vehicle communication unit 300 to the electronic control unit 100.

FIG. 3 shows a method for determining a state of wear of a brake pad.

In a first step S1, time series data Dt are acquired, the time series data Dt comprising a time series of braking-related data of vehicle F. In a second step S2, at least one braking event B1, B2 is identified in the time series data Dt, each braking event identified in the time series data Dt corresponding to a temporal data window of braking event data Db of the time series data, the data window correlating with a real braking event of vehicle F. In a third step S3, features M are determined from the braking event data Db by using predetermined operators for each identified braking event B1, B2. In a fourth step S4, the at least one braking event B1, B2 is classified by using the features M determined for this purpose, the classification K being associated with a state of wear of the brake pad of vehicle F.

FIG. 4 shows time series data Dt, which are temporarily stored in a data memory. In this case, the time series data Dt comprise a vehicle velocity Vveh, a brake light switch state Swl, master brake cylinder pressure data Dp and tire rotational speed data Dd. The time series data Dt comprise data over 9 time steps t0-t8, for which there is space in the indicated memory segment. In other words, the master brake cylinder pressure data Dp comprise multiple data sets Dp0, Dp1, Dp2, Dp3, Dp4, Dp5, Dp6, Dp7 and Dp8 over time. In the same way, the tire rotational speed data Dd comprise multiple data sets Dd0, Dd1, Dd2, Dd3, Dd4, Dd5, Dd6, Dd7 and Dd8 over time. The individual data sets of the master brake cylinder data Dp and tire rotational speed data Dd are here illustrated as placeholders, since their precise value is unimportant in this case. Likewise, the vehicle velocity comprises the respective velocity of the vehicle over time (here in meters per second). The brake light switch state Swl indicates by an A for active and by a D for inactive whether or not the brake light of the vehicle is activated in the respective time step.

FIG. 4 is to explain the identification of a first braking event B1 and a second braking event B2 from the time series data Dt. On the one hand, the brake light switch state Swl is used for this purpose. At every time step at which the value A is reported, a braking event is to be assumed, that is, here in the time steps t0-t2, t4 and t6-t7. At time step t4, however, the vehicle velocity Vveh is only 3 meters per second and thus below a previously defined limit value for a braking event. Therefore, only the time steps t0-t2 are identified as a first braking event B1 and the time steps t6-t7 are identified as a second braking event B2. Consequently, the respective data sets Dp0, Dp1, Dp2 and Dd0, Dd1, Dd2 are identified as braking event data Db of the first braking event B1, and the data sets Dp6, Dp7 and Dd6, Dd7 are identified as braking event data Db of the second braking event B2. The braking event data Db remain in the memory until features M have been determined from them for the machine learning model 33. The other data sets are discarded in order to obtain space in the memory for new time series data.

1-14. (canceled)

15. A method for determining a state of wear of a brake pad of a vehicle, comprising the following steps:
receiving time series data, the time series data including a time series of brake system-related data of the vehicle;
identifying at least one braking event in the time series data, each braking event identified in the time series data corresponding to a temporal data window of braking event data of the time series data, the data window correlating with a real braking event of the vehicle;
determining features from the braking event data by using predetermined operators for every identified braking event;
classifying the at least one braking event by using the determined features, the classification being associated with a state of wear of the brake pad of the vehicle.

16. The method as recited in claim 15, wherein the braking-related data include sensor data and/or control device data and/or brake system data of the vehicle.

17. The method as recited in claim 16, wherein the sensor data are provided by a master brake cylinder pressure sensor and/or a tire rotational speed sensor and/or a vehicle inertial sensor and/or a brake system sensor.

18. The method as recited in claim 16, wherein the brake system data include a brake system status and/or a brake system flag.

19. The method as recited in claim 15, wherein the identification of the at least one braking event includes:
receiving at least one brake trigger, the brake trigger correlating with a real braking event of the vehicle;
identifying the at least one braking event by using the at least one received brake trigger.

20. The method as recited in claim 15, wherein the at least one brake trigger includes a state of the brake light switch and/or a longitudinal acceleration of the vehicle and/or a motor state.

21. The method as recited in claim 15, further comprising:
discarding superfluous time series data which cannot be assigned to a braking event.

22. The method as recited in claim 15, further comprising:
discarding time series data which are not suitable for determining features.

23. The method as recited in claim 15, further comprising:
assigning a relevance to each of the determined features;
using a previously defined number of features having a highest relevance for classifying the at least one braking event.

24. The method as recited in claim 15, wherein the receiving of the time series data includes:
storing the received time series data in a memory;
wherein the time series data are retained in the memory for as long as the memory is not exhausted or as long as the features of the time series data have not been determined.

25. The method as recited in claim 15, wherein the at least one braking event is classified by taking into account a braking history of the vehicle.

26. The method as recited in claim 15, further comprising:
receiving temperature data, wherein the temperature data include a temperature of the brake pad and/or a temperature of a brake disk of the vehicle and/or an ambient temperature of the vehicle;
classifying the at least one braking event by using the determined features and the temperature data.

27. A device configured to determine a state of wear of a brake pad of a vehicle, the device configured to:
receive time series data, the time series data including a time series of brake system-related data of the vehicle;
identify at least one braking event in the time series data, each braking event identified in the time series data corresponding to a temporal data window of braking event data of the time series data, the data window correlating with a real braking event of the vehicle;
determine features from the braking event data by using predetermined operators for every identified braking event;
classify the at least one braking event by using the determined features, the classification being associated with a state of wear of the brake pad of the vehicle.

28. A non-transitory computer-readable medium on which is stored a computer program for determining a state of wear of a brake pad of a vehicle, the computer program, when executed by a computer, causing the computer to perform the following steps:
receiving time series data, the time series data including a time series of brake system-related data of the vehicle;
identifying at least one braking event in the time series data, each braking event identified in the time series data corresponding to a temporal data window of braking event data of the time series data, the data window correlating with a real braking event of the vehicle;
determining features from the braking event data by using predetermined operators for every identified braking event;
classifying the at least one braking event by using the determined features, the classification being associated with a state of wear of the brake pad of the vehicle.
